(19) United States
(12) Patent Application Publication
(10) Pub. No.: US 2009/0150436 A1
(43) Pub. Date: Jun. 11, 2009

(54) METHOD AND SYSTEM FOR CATEGORIZING TOPIC DATA WITH CHANGING SUBTOPICS

(75) Inventors: Shantanu Godbole, New Delhi (IN); Raghuram Krishnapuram, Bangalore (IN); Shourya Roy, New Delhi (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: International Business Machines Corporation, Armonk, NY (US)

(21) Appl. No.: 11/953,198

(22) Filed: Dec. 10, 2007

(51) Int. Cl. G06F 17/30

(52) U.S. Cl. 707/104.1; 707/E17.089

(57) ABSTRACT

The embodiments of the invention provide a method for the automatic identification of changing subtopics within topics. The method begins by receiving customer satisfaction data having unstructured data objects. Next, the data objects are automatically categorized into pre-defined topics, wherein the pre-defined topics do not change throughout the customer satisfaction analysis. The pre-defined topics can be automatically defined based on a history of customer satisfaction data. Following this, a clustering analysis is automatically performed to identify subtopics of the data objects within the pre-defined topics. The subtopics are more specific than the pre-defined topics, and the subtopics can change. Further, the clustering analysis can include extracting features from the data objects and grouping the features into the subtopics. Each of the subtopics includes features having a predetermined degree of similarity.

### BACKGROUND

1. Field of the Invention

Embodiments of the invention generally relate to methods, program storage devices, etc. for the identification of changing subtopics, preferably without any human intervention, within categories for customer satisfaction analysis.

2. Description of the Related Art

Customer satisfaction is a business term which is used to capture the idea of measuring satisfaction of an enterprise's customers with an organization's efforts in a defined market segment or generally in a marketplace. Typically, customer satisfaction (also referred to herein as “C-Sat”) analysis is used by contact centers, Customer Relationship Management (CRM) organizations, help desks, Business Process Outsourcing organizations (BPOs), and Knowledge Process Outsourcing organizations (KPOs) etc. For example, in contact centers, C-Sat analyses are often part of a Sservice Level Agreement (SLA)/contract. C-Sat analyses are dynamic in nature with issues appearing and disappearing regularly. Moreover, C-Sat analyses involve categorizing customer feedback comments into actionable categories. High level categories can be the same across business processes, but finer evolving actionables are highly process specific. An example of a customer response could be “vague and seemed generic, didn't answer question”.

Without a method and system to improve customer satisfactions analysis, the promise of this technology may never be fully achieved.

### SUMMARY

Embodiments of the invention provide a method for the identification of changing subtopics, preferably automatically, within categories for customer satisfaction analysis. The method begins by receiving customer satisfaction data having unstructured data objects. Next, the data objects are categorized into pre-defined topics, wherein the pre-defined topics do not change throughout the customer satisfaction analysis. The pre-defined topics can be automatically defined based on a history of customer satisfaction data.

Following this, a clustering analysis is performed to identify subtopics of the data objects within the pre-defined topics. The subtopics are more specific than the pre-defined topics. Also, the subtopics can change throughout the customer satisfaction analysis. Further, the clustering analysis can extract features from the data objects and group the features into the subtopics. Each of the subtopics includes features having a predetermined degree of similarity.

Subsequently, the clustering analysis is periodically repeated for every new set of data objects submitted to the system to identify the presence of a new subtopic or the absence of an old subtopic without altering the previously established higher level topics. Thus, the invention continually and automatically identifies subtopics, without altering the established topics. Specifically, the new subtopic includes a group of similar data objects that did not exist during a previous clustering analysis, but exists during the current clustering analysis. Moreover, the old subtopic includes a group of similar data objects that existed during the previous clustering analysis, but does not exist during the current clustering analysis. The clustering analyses are performed preferably without user interaction. In addition, the method adds the new subtopic to the subtopics and/or removes the old subtopic from the subtopics. The subtopics are subsequently output. One of more of the above defined steps can be performed without any human intervention (hereinafter referred to as automatically).

Accordingly, the embodiments of the invention build an classification system on high level categories (super-classes or topics). In one embodiment, the classification system may be built automatically. These high level categories can have a large number of training examples to guarantee accuracy. As the high level categories are defined a-priori, there is no scope of adhoc addition/deletion of categories. After the classification of categories, a second phase is performed to identify subcategories (i.e., equivalent topics, concepts, or labels) within each category. Specifically, the second phase identifies actionable low level, fine subcategories which can be used to perform detailed analyses. In one embodiment, the second phase may be implemented automatically. In addition, the second phase can be used for identifying subtopics that vary over time.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a hierarchy of classes for customer satisfaction analysis;

FIG. 2 illustrates automatically generated cluster labels;

FIG. 3 illustrates a flow diagram for a method of customer satisfaction analysis; and

FIG. 4 illustrates a program storage device for a method of customer satisfaction analysis.

### DETAILED DESCRIPTION OF PREFERRED EMBODIMENTS

Embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

Embodiments of the invention build an classification system on high level categories (super-classes). In one embodiment, such a system may be built automatically. These high level categories can have a large number of training examples to guarantee accuracy. As the high level categories are defined a-priori, and with manual approval, selection, or input, there is no scope of automated adhoc addition/deletion of these categories. After the classification of categories, a second phase is performed to identify and continually update subcategories (i.e., equivalent topics, concepts, or labels) within each category. Specifically, the second phase automatically identifies actionable low level, fine subcategories which can be used to perform detailed analyses. Thus, the second phase can be used for identifying subtopics that vary over time. In one embodiment, one of more of the above defined steps and/or phases may be performed automatically.

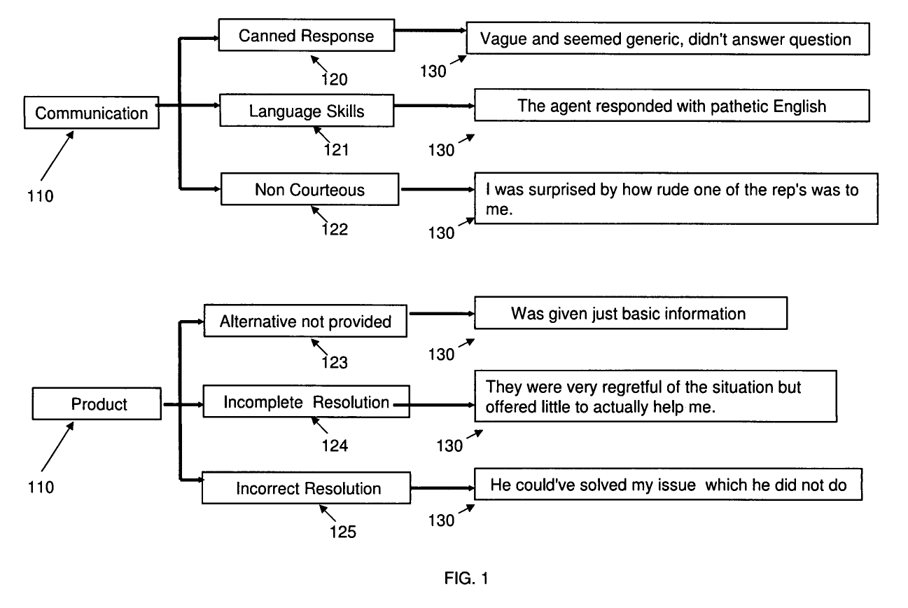

FIG. 1 illustrates a hierarchy of categories for customer satisfaction analysis, wherein super-classes 110 (also referred to herein as “topics” or “categories”) include sub-classes 120-125 (also referred to herein as “subtopics”). Thus, there are hierarchical levels of categories for customer satisfaction data 130. For example, the “Communication” super-class 110 includes the “Canned Response”, “Language Skills”, and “Non Courteous” sub-classes 120-125 of customer satisfaction. Similarly, the “Resolution” super-class 110 includes the “Alternative Not Provided”, “Incomplete Resolution”, and “Incorrect Resolution” sub-classes 120-125 of customer satisfaction.

However, it is neither obvious nor meaningful to define a rigid hierarchy of sub-classes 120-125. The composition of a super-class 110 in terms of subtopics might not be rigidly defined. More often than not, most subtopics do not have a sufficient amount of training data to learn a model using automatic techniques. Furthermore, any such hierarchy can vary over time.

Embodiments of the invention provide supervised classification (preferably automatic categorization via a learning method that uses examples given by a human) followed by unsupervised identification of topics (i.e., automatic clustering after classification). The embodiments herein provide a meaningful solution because customer feedback (commonly and referred to herein as “verbatims”) is classified at a higher level. These high level categories are well defined and non-varying and can be based on human approval or input. Routine monitoring activities and service level agreements are also defined on these categories. Additionally, clustering within categories identifies finer subtopics of interest, which may not be well defined and can vary over time. Moreover, such finer subtopics are actionables, i.e., the finer subtopics help train agents, for example in a call centre, and improve the productivity of agents. Thus, the embodiments herein provide a technique to automatically identify changing subtopics within categories.

The following example is provided for the purpose of illustration. Customer verbatim collections from an eCommerce client account in a contact center are segregated into groups over a different time window. In particular, verbatims collected over the time periods from July to December are divided into 6 groups. Each group is categorized according to a set of flat labels through a classification engine. Documents belonging to different classes (per month data) are separately passed through a clustering method. An optimal number of clusters varies across clusters and/or across different time windows. The embodiments herein maximize a measure proportional to the ratio of intra-cluster to inter-cluster similarities, which confirms the proposition that a fixed class (tree) structure is not meaningful in this scenario.

The fraction of cases belonging to different classes varies over time. Such a variation can increase for some classes such as “Time Adherence”. Some classes are homogeneous over time, such as “Communication”; and, some classes are not homogenous, such as “Uncontrollable”. Features extracted during clustering are more specific and to-the-point (succinct), and are compared to features used during classification.

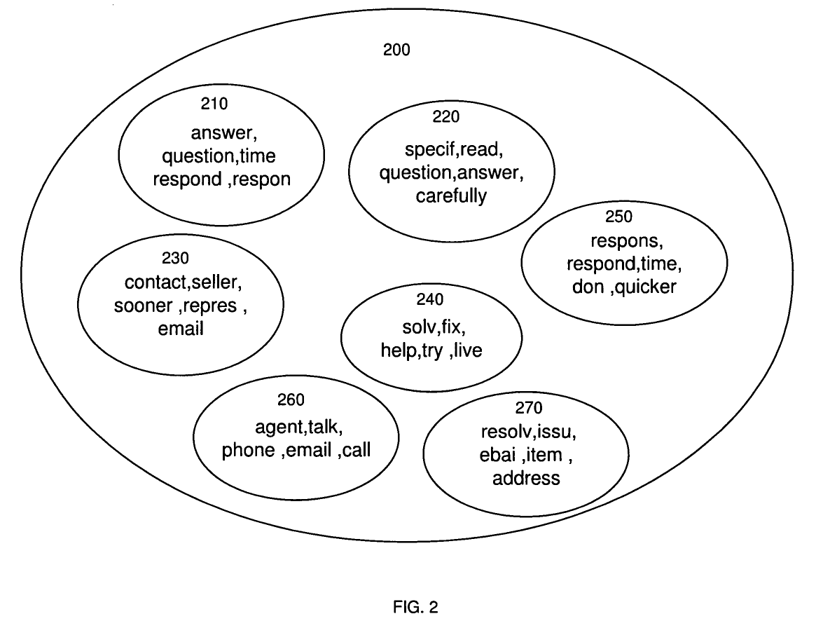

FIG. 2 is a diagram illustrating generated clusters, where in one embodiment the cluster may be generated automatically. This example includes subtopics of the “product/resolution” topic 200. Typically, verbatims containing customer's complaints about non-resolution of issues are categorized in topic 200. More specifically, C-Sat classes 210, 220, 230, 240, 250, 260, and 270 are shown. Table 1A shows exemplary data within the C-Sat class 210; and, Table 1B shows exemplary data within the C-Sat class 220. For example, the customer responses “Give more information with regards to my problems verses generic answers”, “Answered my question instead of putting me off”, and “Actually answered my question” are categorized in the C-Sat class 210. Additionally, the customer responses “Read my question thoroughly and answer it”, “Read and understand the question or problem. Then the response would not be off the subject”, and “Given a more rapid & specific answers to my questions” are categorized in the C-Sat class 220.

TABLE 1A
Answer the question.
Answered the question and taken action.
Give more information in regards to my problems verses generic answers
Answered the question
Answer the question. The issue was not with my computer, it was the
XXXX TM template changing &not giving choices.
Answered much faster . . . I was a wreck
Has already been answered.
My question was not answered, in fact, I later figured it out myself. The
representative told me take steps that I had already mentioned
doing. I garnered no new information whatsoever.
Answered my question instead of putting me off
Actually answered my question.
Being able to get instructions that answered the problem instead of having
me bounce back and forth in your web pages and ending
up where I started.

TABLE 1B
Answered my specific question.
The rep could have answered the very specific question I asked
about a specific transaction with a YYYY seller and what XXXX
TM rules applied. The non-answer suggested to me no desire to
get involved in a question which might involve a
small amount of research.
Answered the specific question I asked.
They could have read my question.
The rep could have read my question. I did not receive a refund. I never
paid, but the responses said it was a question regarding a refund.
Very specific answer to how I resolve this problem of a non-paying buyer!
Answer my question. I think they just read the first sentence.
Read my initial inquiry.
Read my question thoroughly and answer it.
Read and understand the question or problem. Then the response would
not be off the subject.
Given a more rapid &specific answers to my questions.

In addition, Tables 2A-2D illustrates C-Sat data for the “Communication” topic 110 through the months of July-October, respectively. The C-Sat data in italicized text is categorized in a first subtopic of the “Communication” topic 110, the C-Sat data in underlined text is categorized in a second subtopic, and the C-Sat data in bold text is categorized in a third subtopic. For example, the customer responses “Talked to me in person” and “I never got to talk to a representative” were received in July and August, respectively. Both customer responses belong in the first subtopic. Similarly, the customer responses “Your representative should have looked into my matter without giving a “standard” answer” and “The answer to my question was very generic it could have been a bit more helpful to receive a specific answer” were received in September and October, respectively. Both of these customer responses belong in the second subtopic. The “Communication” topic is homogeneous over time as the nature of the subtopics does not change.

TABLE 2A
July

Talked to me in person.
Nothing. I would much prefer to talk to someone
in person.
My question was not really answered and I felt the
response was too vague.
By actually answering my question rather than
cutting and pasting a canned response.
I didn''t have any PERSONAL CONTACT with
anyone!!!
Answered sooner . . . been more personal.

TABLE 2B
August

I never got to talk to a representative.
Talk to me.
Read my question and answered it instead of reading half
of it and sending an auto response.
I felt like they speed read or did not really read the
question but instead read the word best offer and set a
stock automated response.
Could have been more personable . . . I wasn't even
aware there was a person responding to me.
I thought it was a computer generated email.
Personal contact, rather than a boilerplate message,
would have been better.

TABLE 2C
September

Give me a number to call customer support so I
could talk to an actual person!!!
I didn't even talk to one!
Your representative should have looked into my
matter without giving a “standard” answer.
Read your rules and sent me an answer that did
not pertain to my question.
I think perhaps speaking to a “real” person, as
opposed to trying to explain the situation in an
e-mail.
Provide a telephone number to speak with a
person!!!

TABLE 2D
October

Have a live contact to talk to.
Easy contacts with a real person.
The answer to my question was very generic it could
have been a bit more helpful . . .
As previously stated, everything is answered in a
general way, almost to the point of seeming like a
generated letter.
If this person would have solved the problem
rather than just talk (write) about it!

The top five discriminative features from the three subtopics within the “Communication” class 110 are shown in Table 3A. Table 3B illustrates the top 20 features within the “Communication” class 110. Subtopic features are more specific than the high level class features.

TABLE 3A

talk, human, didn, agent, 800, real
person, faster, real, respons, live
answer, question, can, respons, inst
help, address, send, issu, actual
email, call, autom, XXXX, respons

TABLE 3B

question, canned, response, answer, read, automated, standard,
specific, generic, reply, representative, personal, giving, answers,
problem, felt, issue, answered, sending, understand

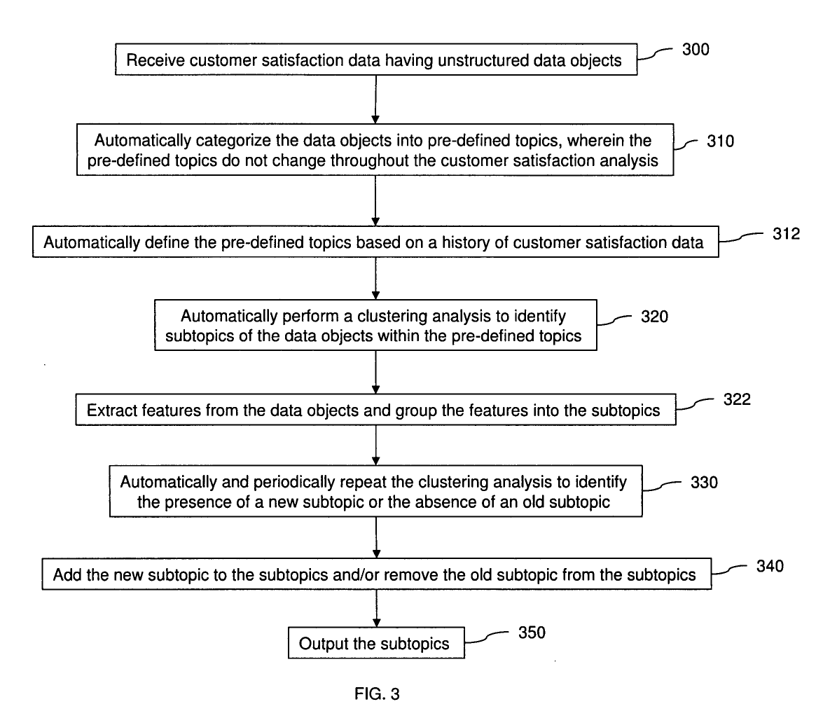

FIG. 3 illustrates a flow diagram of one embodiment for the automatic identification of changing subtopics within categories for customer satisfaction analysis. The method begins by receiving customer satisfaction data having unstructured data objects (item 300). Next, the data objects are categorized into pre-defined topics, wherein the pre-defined topics do not change throughout the customer satisfaction analysis (item 310). Examples of pre-defined topics are illustrated in FIG. 1 (“Communication 110” and “Product 110”) and FIG. 2 (topic 200). The pre-defined topics can be defined based on a history of customer satisfaction data (item 312).

Following this, a clustering analysis is performed to identify subtopics of the data objects within the pre-defined topics (item 320). As described above, the embodiments of the invention provide supervised classification (automatic categorization via a learning method that uses examples given by a human) followed by unsupervised identification of subtopics (i.e., automatic clustering after classification). In one embodiment, one or more of the above defined steps may be performed automatically.

The subtopics are more specific than the pre-defined topics, and the subtopics can change throughout the customer satisfaction analysis. Further, the clustering analysis extracts features (e.g., topics, concepts, labels, etc.) from the data objects and groups the features into the subtopics (item 322). Each of the subtopics includes features having a predetermined degree of similarity.

Referring back to FIG. 1, for example, the method identifies “Canned Response” subtopic 120, “Language Skills” subtopic 121, and “Non Courteous” subtopic 122 within the “Communication” topic 110. Such subtopics 120-122 are more specific than the “Communication” topic 110. Similarly, the method identifies “Alternative not provided” subtopic 123, “Incomplete Resolution” subtopic 124, and “Incorrect Resolution” subtopic 125 within the “Product” topic 110. Such subtopics 123-125 are more specific than the “Product” topic 110.

Subsequently, the clustering analysis is periodically repeated to identify the presence of a new subtopic or the absence of an old subtopic (item 330), which in one embodiment may be performed automatically. As described above, clustering within categories identifies finer interesting subtopics, which may not be well defined and can vary over time. Such fine subtopics are actionables, i.e., the fine subtopics help train agents and improve the productivity of agents. Thus, the embodiments herein provide a technique to identify changing subtopics within categories, which in one embodiment may be performed automatically.

Specifically, the new subtopic includes a group of similar data objects that did not exist during a previous clustering analysis, but exists during the current clustering analysis. Moreover, the old subtopic includes a group of similar data objects that existed during the previous clustering analysis, but does not exist during the current clustering analysis. The clustering analyses are performed without user interaction, preferably automatically. In addition, the method adds the new subtopic to the subtopics and/or removes the old subtopic from the subtopics (item 340). The subtopics are subsequently output (item 350).

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

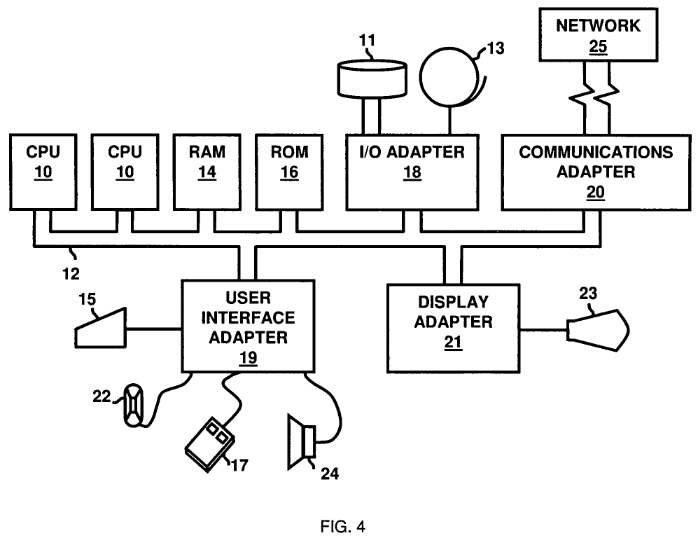

A representative hardware environment for practicing the embodiments of the invention is depicted in FIG. 4. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Accordingly, the embodiments of the invention build an classification system on high level categories (super-classes). Perferably, in one embodiment such a classification system is built automatically. These high level categories can have a large number of training examples to guarantee accuracy. As the high level categories are defined a-priori, there is no scope of adhoc addition/deletion of categories. After the classification of categories, a second phase is performed to identify subcategories (i.e., equivalent topics, concepts, or labels) within each category. Specifically, the second phase identifies actionable low level, fine subcategories which can be used to perform detailed analyses. In addition, the second phase can be used for identifying subtopics that vary over time. In one embodiment, the second phase may be executed automatically.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method for categorizing data objects into at least one of relevant categories of topics and sub-topics, said method comprising:
receiving data comprising unstructured data objects;
categorizing said data objects into pre-defined topics;
performing a clustering analysis to identify subtopics of said data objects within said pre-defined topics, wherein said subtopics are more specific than said pre-defined topics;
periodically repeating said clustering analysis to identify at least one of a presence of a new subtopic and an absence of an old subtopic, wherein said new subtopic comprises a group of similar data objects unidentified during a previous clustering analysis and identified during a current clustering analysis, and wherein said old subtopic comprises a group of similar data objects identified during said previous clustering analysis and unidentified during said current clustering analysis;
performing at least one of adding said new subtopic to said subtopics and removing said old subtopic from said subtopics; and
after said adding and said removing, identifying said subtopics and classifying said subtopics into said pre-defined topics.

2. The method according to claim 1, all the limitations of which are incorporated herein by reference, further comprising defining said pre-defined topics based on a history within a history repository of said data.

3. The method according to claim 1, all the limitations of which are incorporated herein by reference, wherein said clustering analysis comprises:
extracting features, wherein said features comprise topics, concepts, and labels from said data objects; and
grouping said features into said subtopics, such that each of said subtopics comprises features comprising a predetermined degree of similarity.

4. The method according to claim 1, all the limitations of which are incorporated herein by reference, wherein at least one of said steps is performed without any human intervention.

5. The method according to claims 1, all the limitations of which are incorporated herein by reference, wherein said clustering analysis and said repeating of said clustering analysis are performed without any human intervention.

6. The method according to claim 1, all the limitations of which are incorporated herein by reference, wherein said pre-defined topics are based on training examples.

7. The method according to claim 1, all the limitations of which are incorporated herein by reference, wherein said subtopics change during said repeating of said clustering analysis.

8. A method for categorizing data objects into at least one of relevant categories of topics and sub-topics, said method comprising:
receiving data comprising unstructured data objects;
categorizing said data objects into pre-defined topics, wherein said pre-defined topics do not change;
performing a clustering analysis to identify subtopics of said data objects within said pre-defined topics, wherein said subtopics are more specific than said pre-defined topics;
periodically repeating said clustering analysis to identify at least one of a presence of a new subtopic and an absence of an old subtopic, wherein said new subtopic comprises a group of similar data objects unidentified during a previous clustering analysis and identified during a current clustering analysis, and wherein said old subtopic comprises a group of similar data objects identified during said previous clustering analysis and unidentified during said current clustering analysis;
performing at least one of adding said new subtopic to said subtopics and removing said old subtopic from said subtopics; and
after said adding and said removing, identifying said subtopics and classifying said subtopics into said pre-defined topics.

9. The method according to claim 8, all the limitations of which are incorporated herein by reference, further comprising defining said pre-defined topics based on a history within a history repository of said data.

10. The method according to claim 8, all the limitations of which are incorporated herein by reference, wherein said clustering analysis comprises:
extracting features, wherein said features comprise topics, concepts, and labels from said data objects; and
grouping said features into said subtopics, such that each of said subtopics comprises features comprising a predetermined degree of similarity.

11. The method according to claim 8, all the limitations of which are incorporated herein by reference, wherein at least one of said steps is performed without any human intervention.

12. The method according to claims 8, all the limitations of which are incorporated herein by reference, wherein said clustering analysis and said repeating of said clustering analysis are performed without any human intervention.

13. The method according to claim 8, all the limitations of which are incorporated herein by reference, wherein said pre-defined topics are based on training examples.

14. The method according to claim 8, all the limitations of which are incorporated herein by reference, wherein said subtopics change during said repeating of said clustering analysis.

15. A program storage device readable by computer, tangibly embodying a program of instructions executable by said computer to perform a method for categorizing data objects into at least one of relevant categories of topics and sub-topics, said method comprising:
receiving data comprising unstructured data objects;
categorizing said data objects into pre-defined topics;
performing a clustering analysis to identify subtopics of said data objects within said pre-defined topics, wherein said subtopics are more specific than said pre-defined topics;
periodically repeating said clustering analysis to identify at least one of a presence of a new subtopic and an absence of an old subtopic, wherein said new subtopic comprises a group of similar data objects unidentified during a previous clustering analysis and identified during a current clustering analysis, and wherein said old subtopic comprises a group of similar data objects identified during said previous clustering analysis and unidentified during said current clustering analysis;
performing at least one of adding said new subtopic to said subtopics and removing said old subtopic from said subtopics; and
after said adding and said removing, identifying said subtopics and classifying said subtopics into said pre-defined topics.

16. The method according to claim 15, all the limitations of which are incorporated herein by reference, further comprising defining said pre-defined topics based on a history within a history repository of said data.

17. The method according to claim 15, all the limitations of which are incorporated herein by reference, wherein said clustering analysis comprises:
extracting features, wherein said features comprise topics, concepts, and labels from said data objects; and
grouping said features into said subtopics, such that each of said subtopics comprises features comprising a predetermined degree of similarity.

18. The method according to claim 15, all the limitations of which are incorporated herein by reference, wherein at least one of said steps is performed without any human intervention.

19. The method according to claims 15, all the limitations of which are incorporated herein by reference, wherein said clustering analysis and said repeating of said clustering analysis are performed without any human intervention.

20. The method according to claim 15, all the limitations of which are incorporated herein by reference, wherein said pre-defined topics are based on training examples.
